(19) United States
(12) Patent Application Publication
(10) Pub. No.: US 2020/0338717 A1
(43) Pub. Date: Oct. 29, 2020

(54) Fixturing System for Woodwoorking

(71) Applicant: ToolQuest, LLC, Galena, OH (US)

(72) Inventor: Dennis R. Pugh, Galena, OH (US)

(21) Appl. No.: 16/838,284

(22) Filed: Apr. 2, 2020

Related U.S. Application Data
(60) Provisional application No. 62/837,747, filed on Apr. 24, 2019.
(60) Provisional application No. 62/892,190, filed on Aug. 27, 2019.
(60) Provisional application No. 62/963,825, filed on Jan. 21, 2020.

(51) Int. Cl. B25H 1/08; B27C 5/10

(52) U.S. Cl. CPC B25H 1/08; B27C 5/10

(57) ABSTRACT

A fixturing system for woodworking includes a woodworking table having a planar top surface and a T-slot. The T-slot has a central section that is open at the top surface, and further has a pair of undercut sections projecting laterally from opposite sides of the central section. The table has a pair of inner surfaces facing downward over the pair of undercut sections of the T-slot. The system further includes a T-nut. An upper portion of the T-nut is receivable in the central section of the T-slot, and has a screw-threaded bore. The bore has a nominal cross-sectional area for receiving a screw-threaded shank on a fastener. A lower portion of the T-nut has a pair of clamping surfaces projecting laterally from opposite sides of the upper portion. The clamping surfaces on the T-nut have a combined surface area of at least about 4 times the nominal cross-sectional area of the bore.

### RELATED APPLICATIONS

This application claims priority to provisional U.S. patent application Ser. No. 62/837,747, filed Apr. 24, 2019, provisional U.S. patent application Ser. No. 62/892,190, filed Aug. 27, 2019, and provisional U.S. patent application Ser. No. 62/963,825, filed Jan. 21, 2020, each of which in incorporated by reference in its entirety.

### TECHNICAL FIELD

This technology includes devices for securing a workpiece on a working surface.

### BACKGROUND

A woodworking table may have T-slots containing T-nuts. A user can slide the T-nuts along the lengths of the T-slots to place them in selected positions on the table. The user can then fasten woodworking fixtures to the T-nuts at the selected positions. The fixtures can then support a workpiece on the table in a corresponding orientation. If the table is formed of wood-based material, the T-slots can be provided in metal T-tracks that are installed in the wood-based material. The metal T-tracks can withstand the forces exerted by the T-nuts and fixtures.

### SUMMARY

A system includes a structural element configured to serve as a substrate for supporting woodworking hardware. The structural element has an outer surface, and has inner surfaces defining a T-slot. The T-slot has a central section that is open at the outer surface. A pair of undercut sections of the T-slot project from opposite sides of the central section. The inner surfaces of the structural element include a pair of inner surfaces facing inward across the undercut sections of the T-slot.

The system further includes a T-nut. An outer portion of the T-nut is receivable in the central section of the T-slot, and has a screw-threaded bore. The bore has a nominal cross-sectional area for receiving a screw-threaded shank on a fastener. An inner portion of the T-nut has a pair of clamping surfaces projecting from opposite sides of the outer portion. The clamping surfaces on the T-nut have a combined surface area of at least about 4 times the nominal cross-sectional area of the bore.

In a given example, the clamping surfaces on the T-nut are coplanar with one another. In another given example, the clamping surfaces on the T-nut are inclined so as to project inward relative to the outer portion of the T-nut. In that example, the features of combined surface area apply to the sum of the areas projected from the clamping surfaces onto a plane of the outer surface in a direction perpendicular to the outer surface.

### BRIEF DESCRIPTION OF THE DRAWINGS

FIG. 1 is a top view of a woodworking table.

FIG. 2 is a perspective view, taken from above, of a T-nut for use with the woodworking table of FIG. 1.

FIG. 3 is a perspective view, taken from below, of the T-nut of FIG. 2.

FIG. 4 is an end view of the T-nut of FIG. 2.

FIG. 5 is a top view of the T-nut of FIG. 2.

FIG. 6 is a partial side view of the woodworking table of FIG. 1, showing a T-slot.

FIG. 7 is a view similar to FIG. 6, further showing the T-nut installed in the T-slot.

FIG. 8 is a view similar to FIG. 6, showing a side view of an alternative embodiment of a woodworking table with a T-slot.

FIG. 9 is a view similar to FIG. 4, showing an end view of an alternative embodiment of a T-nut.

FIG. 10 is a view similar to FIG. 7, showing the T-nut of FIG. 9 installed in the T-slot of FIG. 8.

FIG. 11 is a partial side view of a tool for forming the T-slot of FIG. 8.

### DETAILED DESCRIPTION

The structures illustrated in the drawings include parts that are examples of the elements recited in the claims. The illustrated structures thus include examples of how a person of ordinary skill in the art can make and use the claimed invention. They are described here to meet the enablement and best mode requirements of the patent statute without imposing limitations that are not recited in the claims. One or more of the elements of one embodiment may be used in combination with, or as a substitute for, one or more elements of another as needed for any particular implementation of the invention.

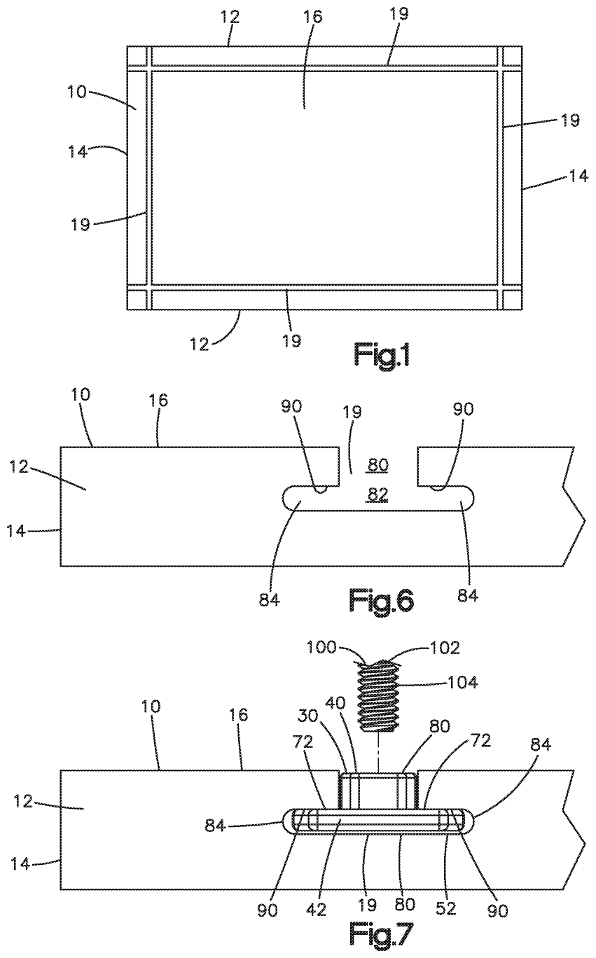

As shown in FIG. 1, an example of a structural element is provided in the configuration of a woodworking table 10. In this embodiment, the table 10 is formed of wood-based material such as, for example, natural wood or engineered materials including plywood, particle board and fiberboard. As shown in FIG. 1, the table 10 in this example has a rectangular shape with opposite side edges 12 and opposite end edges 14. The table 10 has a planar top surface 16, and has T-slots 19 that are open at the top surface 16. In the illustrated embodiment, there are two parallel T-slots 19 reaching across the width of the top surface 16 from one side edge 12 to the other side edge 12. Those T-slots 19 are open at the side edges 12. Two more parallel T-slots 19 reach along the length of the top surface 16 from one end edge 14 to the other end edge 14, and are open at the end edges 14. As shown, the table 10 in the illustrated example does not contain metal T-tracks.

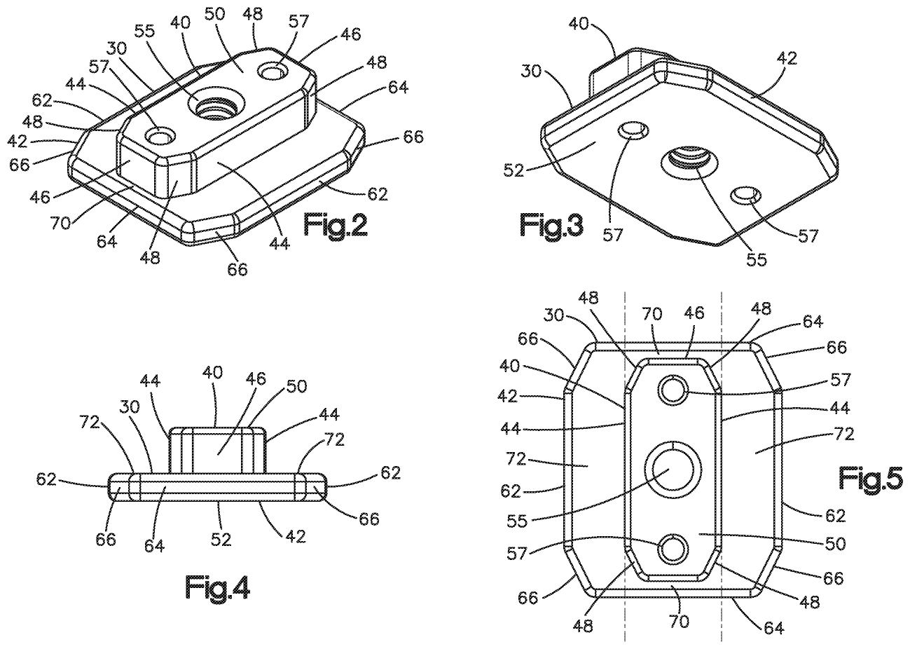

The woodworking system further includes a plurality of T-nuts 30. In the illustrated embodiment, each T-nut 30 has the configuration shown for example in FIGS. 2-5. Each T-nut 30 thus has an outer or upper portion 40, and also has an inner or lower portion 42. The upper portion 40 has an elongated shape with opposite sides 44, opposite ends 46, and beveled corners 48. The T-nut 30 has a planar top surface 50 on the upper portion 40, and has a planar bottom surface 52 (FIGS. 3 and 4) on the lower portion 42. A screw-threaded bore 55 reaches vertically through the T-nut 30 from the center of the top surface 50 to the center of the bottom surface 52. The bore 55 has a nominal cross-sectional area for a screw-threaded shank on a fastener to be screwed into the bore 55. Sockets 57 for anti-rotation pins also extend vertically through the T-nut 30.

The lower portion 42 of the T-nut 30 also has an elongated shape with opposite sides 62, opposite ends 64, and beveled corners 66. As best shown in FIG. 5, a pair of coplanar end surfaces 70 are located at the opposite ends 64 of the lower portion 42. The end surfaces 70 project longitudinally outward from the opposite ends 44 and beveled corners 46 of the upper portion 40. A pair of clamping surfaces 72 on the lower portion 42 of the T-nut 30 project laterally away from the opposite sides 44 of the upper portion 40. The clamping surfaces 72 are coplanar and equal in size, with each having a predetermined area. When the T-nut 30 is in the level, upright orientation as shown in FIG. 4, which is the ordinary position of use with a table 10 as shown in FIG. 7, the end surfaces 70 and the clamping surfaces 72 are horizontal, and are thus parallel to the top surface 16 of the table 10.

As described above with reference to the top view of FIG. 1, the T-slots 19 are open at the side and end edges 12 and 14 of the table 10. This is shown for example in the partial side view of FIG. 6. As further shown in FIG. 6, each T-slot includes a central section 80 and a channel 82 beneath the central section 80. The central section 80 is open at the horizontal top surface 16 of the table 10. The channel 82 has a pair of undercut sections 84 reaching laterally from the central section 80. Horizontal inner surfaces 90 of the table 10 face downward over the undercut sections 84 of the channel 82.

Each T-nut 30 is sized and shaped to fit within a T-slot 19 as shown in FIG. 7. The width of the T-nut 30 at the upper portion 40 is slightly less than the width of the T-slot 19 at the central section 80. The width of the T-nut 30 at the lower portion 42 is slightly less than the width of the T-slot 19 at the channel 80. The thickness of the T-nut 30 between the bottom surface 52 and the clamping surfaces 72 is slightly less than the height of the T-slot 19 in the undercut sections 84 of the channel 80. In this configuration, the T-nut 30 can be inserted into the T-slot 19 through the open end for sliding movement to any desired position along the length of the T-slot 19.

Also shown partially in FIG. 7 is a fastener 100 with a shank 102. The shank 102 has a screw-thread 104 and a nominal cross-sectional area equal to that of the bore 55 in the T-nut so that the shank 102 can be screwed into the bore 55 in the T-nut 19. The fastener 100 can be installed to secure a fixture in place on the top surface 16 of the table 10 at the location of the T-nut 30. Anti-rotation pins can be extended from the fixture into the sockets 57 to secure the T-nut and fixture in alignment with the T-slot 19.

When the fastener 100 is tightened, it pulls the T-nut 30 upward while simultaneously pressing the fixture downward. This applies clamping forces upward from the clamping surfaces 72 on the T-nut 30 to the inner surfaces 90 of the table 10 in the undercut sections 84 of the channel 80. Such clamping forces tend to compress the wood-based material of the table 10 between the inner surfaces 90 and the top surface 16. For this reason, the clamping surfaces 72 on the T-nut and the inner surfaces 90 of the table 10 are sized to distribute the compressive clamping forces sufficiently to avoid destructive compression of the table 10 without the need for a metal T-track. Specifically, the sum of the two surface areas at the clamping surfaces 72 is at least about 4 times the nominal cross-sectional area of the bore 55 for receiving the screw-threaded shank 102 on the fastener 100. The combined area of the inner surfaces 90 in overlying contact with the clamping surfaces 72 is at least as large.

Although the clamping surfaces 72 in the given example have a combined area of at least about 4 times the nominal cross-sectional area of the bore 55 and the shank 102, the combined area of the clamping surfaces 72 may be larger as needed depending on the wood-based material of which the table 10 is formed. Examples include combined areas of at least about 10 times the nominal cross-sectional area of the bore 55, such as a combined area of 9.8 times the nominal cross-sectional area of the bore 55.

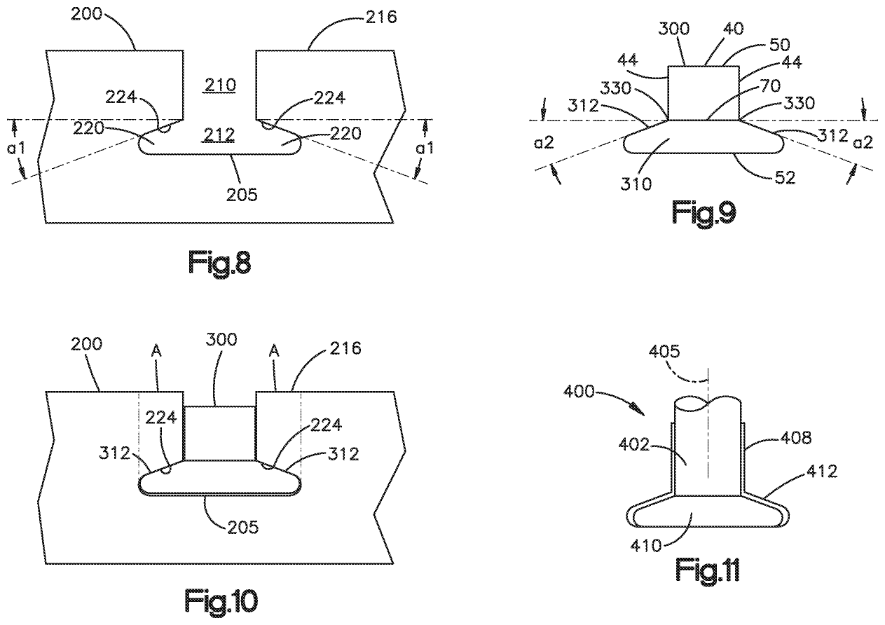

In an alternative embodiment, a woodworking table 200 has the configuration shown partially in FIG. 8. Like the table 10 described above, the table 200 has a T-slot 205 with a central section 210 and a channel 212 beneath the central section 210. The central section 210 is open at a horizontal planar top surface 216 of the table 200. The channel 212 has a pair of undercut sections 220 reaching laterally from the central section 210. A pair of inner surfaces 224 of the table 200 face downward over the undercut sections 220 of the channel 212. The inner surfaces 224 are planar and of equal size. However, unlike the corresponding inner surfaces 90 of the table 10 described above, the inner surfaces 224 in this embodiment are not parallel to the respective top surface 216, but instead are inclined relative to the respective top surface 216. Specifically, the inner surfaces 224 project downward and transversely away from the central section 210 of the T-slot 205 at equal angles of inclination a1.

A T-nut 300 for use with the table 200 is shown in FIG. 9. In this embodiment, the T-nut 300 has several parts that are substantially the same as corresponding parts of the T-nut 30 described above. This is indicated by the use of the same reference numbers for such parts in FIGS. 4 and 9. However, the T-nut 300 has a lower portion 310 with a pair of clamping surfaces 312 that differ from the clamping surfaces 72 on the lower portion 42 of the T-nut 30. These clamping surfaces 312 are not horizontal when the T-nut 300 is in the level, upright orientation shown in FIG. 9. Instead, these clamping surfaces 312 are inclined so as to project downward and transversely away from the upper portion 40 of the T-nut 300. The angles of inclination a2 at the clamping surfaces 312 are equal to one another, and are also equal to the angles of inclination al at the inner surfaces 224 of the table 200. The clamping surfaces 312 are thus inclined relative to the top surface 216 of the table 200 so as to adjoin the inclined inner surfaces 224 when the T-nut 300 is installed in the ordinary position of use as shown in FIG. 10.

Further regarding the inclined inner surfaces 224 and the inclined clamping surfaces 312, each of the angles al and a2 is measured downward from a plane parallel to the top surface 216 as viewed in the drawings, and is preferred to be equal or substantially equal to 18 degrees. By projecting in directions inward of the slot 205, the inner surfaces 224 have downward slopes. Also, compared with the horizontal clamping surfaces 72 of FIG. 4, the inclined clamping surfaces 312 of FIG. 9 project away from the upper portion 40 of the T-nut 300 at angles greater than 90 degrees. This increases the material thickness and reduces the concentration of bending stresses at the inner corners 330 between the upper and lower portions 40 and 310 of the T-nut. The lesser bending stresses permit the T-nut 300 to be formed of correspondingly lesser strength material, such as plastic or predominantly plastic material rather than a metal material. An example is a T-nut formed of glass-fiber filled plastic, plus a threaded insert made of brass for the bore 55. The relatively shallow angles of about 18 degrees are considered to be optimal for providing the increased material while directing the applied forces predominantly upward from the T-nut 300 rather than horizontally away from the T-nut.

Additionally, the inclined clamping surfaces 312 have similar features of combined surface area described above for the clamping surfaces 72. These features of surface area relate to the areas A projected from those surfaces 322 upward to the horizontal top surface 216, as shown in FIG. 10. The sum of those two areas is at least about 4 times the nominal cross-sectional area of the bore 55 for receiving the screw-threaded shank 102 on the fastener 100.

A tool 400 for forming the T-slot 205 of FIG. 8 is shown partially in FIG. 11. The tool 400 is a router bit with a shank 402 having a longitudinal central axis 405. The shank 402 has a cutting edge 408 configured to form the central section 210 of the slot 206. A head 410 on the end of the shank 402 has a cutting edge 412 configured to form the channel 212 in the slot 206. Specifically, the cutting edge 412 on the head 410 is inclined to project downward and transversely away from the cutting edge 408 on the shank 402, and thereby to provide the channel 212 with the inner surfaces 224 that are likewise inclined relative to the top surface 216 of the table 200. The cutting edge 412 is thus configured to ensure that the inner surfaces 224 in the channel 212 will adjoin the clamping surfaces 312 on the T-nut when the T-nut 300 is installed in the ordinary position of use as shown in FIG. 10.

This written description sets for the best mode of carrying out the invention, and describes the invention so as to enable a person of ordinary skill in the art to make and use the invention, by presenting examples of the elements recited in the claims. The detailed descriptions of those elements do not impose limitations that are not recited in the claims, either literally or under the doctrine of equivalents.

What is claimed is:

1. A device for use with a structural element having an outer surface and inner surfaces defining a T-slot, wherein the T-slot has a central section that is open at the outer surface, and further has a pair of undercut sections projecting from opposite sides of the central section, and the inner surfaces of the structural element include a pair of inner surfaces facing inward across the pair of undercut sections of the T-slot, the device comprising:
a T-nut having an outer portion receivable in the central section of the T-slot, a screw-threaded bore in the outer portion, and an inner portion with a pair of clamping surfaces projecting from opposite sides of the outer portion;
wherein the bore has a nominal cross-sectional area for receiving a screw-threaded shank on a fastener, and the clamping surfaces on the T-nut have a combined surface area of at least about 4 times the nominal cross-sectional area of the bore.

2. A device as defined in claim 1, wherein the clamping surfaces on the T-nut have a combined surface area of at least about 10 times the nominal surface area of the bore.

3. A device as defined in claim 2, wherein the clamping surfaces on the T-nut have a combined surface area of 9.8 times the nominal surface area of the bore.

4. A device as defined in claim 1, wherein the clamping surfaces on the T-nut are coplanar with one another.

5. A device as defined in claim 4, wherein the clamping surfaces on the T-nut are horizontal when the T-nut is in a level upright position.

6. A device as defined in claim 1, wherein the outer surface of the structural element is planar, the clamping surfaces on the T-nut are inclined to project inward relative to the outer portion of the T-nut, and the combined surface area is the sum of areas projected from the clamping surfaces onto a plane of the outer surface in a direction perpendicular to the outer surface.

7. A device as defined in claim 6, wherein the T-nut is formed predominantly of plastic.

8. A device as defined in claim 1, wherein the outer surface of the structural element is planar, and the clamping surfaces on the T-nut are inclined so as to project inward relative to the outer portion of the T-nut at angles of inclination equal or substantially equal to 18 degrees.

9. A device as defined in claim 8, wherein the T-nut is formed predominantly of plastic.

10. A fixturing system for woodworking, comprising:
a structural element having a planar top surface and inner surfaces defining a T-slot, wherein the T-slot has a central section that is open at the planar top surface, and further has a pair of undercut sections projecting from opposite sides of the central section, and the inner surfaces of the structural element include a pair of inner surfaces facing downward over the pair of undercut sections of the T-slot; and
a T-nut having an upper portion receivable in the central section of the T-slot, a screw-threaded bore in the upper portion, and a lower portion with a pair of clamping surfaces projecting from opposite sides of the upper portion;
wherein the bore has a nominal cross-sectional area for receiving a screw-threaded shank on a fastener, and the clamping surfaces on the T-nut have a combined surface area of at least about 4 times the nominal cross-sectional area of the bore.

11. A fixturing system as defined in claim 10, wherein the clamping surfaces on the T-nut have a combined surface area of at least about 10 times the nominal surface area of the bore.

12. A fixturing system as defined in claim 10, wherein the clamping surfaces on the T-nut have a combined surface area of 9.8 times the nominal surface area of the bore.

13. A fixturing system as defined in claim 10, wherein the structural element is formed of material comprising a wood-based material, and the T-slot is formed by surfaces of the wood-based material.

14. A fixturing system as defined in claim 10, wherein the clamping surfaces on the T-nut are coplanar with one another.

15. A fixturing system as defined in claim 14, wherein the clamping surfaces on the T-nut are horizontal when the T-nut is in a level upright position.

16. A fixturing system as defined in claim 10, wherein the clamping surfaces on the T-nut are inclined so as to project downward relative to the upper portion of the T-nut, and the combined surface area is the sum of areas projected from the clamping surfaces upward to the planar top surface in a direction perpendicular to the planar top surface.

17. A device as defined in claim 16, wherein the T-nut is formed predominantly of plastic.

18. A fixturing system as defined in claim 10, wherein the inner surfaces of the structural element are inclined to project downward relative to the top surface of the structural element at angles of inclination of approximately 18 degrees.

19. A device as defined in claim 18, wherein the T-nut is formed predominantly of plastic.

20. A tool for manufacturing a structural element having an outer surface and inner surfaces defining a T-slot, wherein the T-slot has a central section that is open at the outer surface, and further has a pair of undercut sections projecting from opposite sides of the central section, and the inner surfaces of the structural element include a pair of inner surfaces facing inward across the pair of undercut sections of the T-slot, the tool comprising:
a router bit having a shank portion with a cutting edge configured to form the central section of the T-slot, and further having head portion with a cutting edge configured to form the inner surfaces of the structural element in configurations that are inclined to project inward relative to the outer surface of the structural element at angles of inclination equal or substantially equal to 18 degrees.
